(19) United States
(12) Patent Application Publication
(10) Pub. No.: US 2020/0083787 A1
(43) Pub. Date: Mar. 12, 2020

(54) LASER WELDING METHOD FOR COIL WIRES

(71) Applicants: TOYOTA JIDOSHA KABUSHIKI KAISHA, Toyota-shi (JP); DENSO CORPORATION, Kariya-city (JP)

(72) Inventors: Tadashi FUJIYOSHI, Anjo-shi (JP); Yasuyuki HIRAO, Okazaki-shi (JP); Yoshiki YAMAUCHI, Okazaki-shi (JP); Hiroaki TAKEDA, Kariya-city (JP); Masaya NAKAMURA, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 16/565,769

(22) Filed: Sep. 10, 2019

(30) Foreign Application Priority Data
Sep. 12, 2018 (JP) 2018-170711

(51) Int. Cl. H02K 15/00; B23K 26/082; B23K 26/06; B23K 26/22

(52) U.S. Cl. CPC H02K 15/0081; B23K 26/22; B23K 26/0626; B23K 26/082

(57) ABSTRACT

A laser welding method for coil wires includes welding two coil wires by irradiating a laser beam to an upper end edge of butted surfaces of side surfaces of tip end portions of the two coil wires. At this time, a molten pool is formed at the center of a welding portion on the upper end edge by scanning the laser beam in a plurality of continuous loop shapes from one or both welding end portions, and welding is performed to make the molten pool at the center portion of the welding portion greater in welding depth than other molten pools by controlling at least one among a movement pitch, a loop area, a laser scanning speed, and a laser power of loops of the laser beam.

### CROSS REFERENCE TO RELATED APPLICATION

This application claims priority to Japanese Patent Application No. 2018-170711 filed on Sep. 12, 2018, which is incorporated herein by reference in its entirety including the specification, claims, drawings, and abstract.

### TECHNICAL FIELD

This specification discloses a laser welding method for coil wires to weld tip end portions of two coil wires by irradiation of a laser beam.

### BACKGROUND

JP 2018-20340 A discloses a laser welding method for welding two coil wires by irradiating a laser beam to upper ends of butting portions of tip end portions of two coil wires. This method forms a molten pool by scanning the laser beam in a loop shape on the tip end portion of one of the coil wires, which is different from two butted surfaces (contact surfaces) of side surfaces of the tip end portions of the two coil wires, and gradually enlarging the loops so as to reach the upper ends of the butted surfaces.

According to the method described in JP 2018-20340 A, the loop has an excessively large diameter when the laser beam reaches the upper ends of the butted surfaces, the molten pool solidifies partly due to a temperature drop, and the energy of the laser beam is taken for remelting the solidified pool. Therefore, a welding area cannot be expanded in the vertical direction of the butted surfaces, and there still remains room for improvement to enhance the bonding strength between the coil wires.

When the tip end portions of two coil wires are laser-welded, the butted surfaces often have a shape such that a welding margin (weldable range) in the vertical direction becomes larger than others at a position corresponding to the center of an upper end edge.

Accordingly, the present specification discloses a laser welding method that can enlarge a welding area of tip end portions of two coil wires according to the butted surfaces having the above-described shape.

### SUMMARY

The laser welding method for coil wires disclosed in the present specification is a laser welding method for coil wires, the method comprising welding two coil wires by irradiating a laser beam to an upper end edge of butted surfaces of side surfaces of tip end portions of the two coil wires, wherein a molten pool is formed at the center of a welding portion on the upper end edge of the butted surfaces of the two coil wires by scanning the laser beam in a plurality of continuous loop shapes from one or both welding end portions, and welding is performed to make the molten pool at the center portion of the welding portion greater in welding depth than other molten pools by controlling at least one among a movement pitch, a loop area, a laser scanning speed, and a laser power of loops of the laser beam.

By configuring as described above, a plurality of small molten pools can be formed from a plurality of loops on an upper end edge of the butted surfaces. Thus, different from the butted surfaces of two coil wires as in JP 2018-20340 A, a diameter of molten pools can be made smaller, which different from a case that the laser beam is scanned in a loop shape on the tip end portion of a single coil wire to form the molten pools, and the loops are gradually enlarged so as to reach the upper end of the butted surfaces. Therefore, solidification of the molten pools can be suppressed when the respective loops are formed on the butted surfaces, thereby suppressing taking of the laser beam energy by remelting of the molten pools. Therefore, the welding area can be expanded vertically on the butted surfaces. In addition, the welding area can be made larger by welding so that the molten pool at the center portion comes to have a greater depth than other pools.

The welding area of tip end portions of two coil wires can be increased according to the laser welding method for coil wires disclosed in this specification.

### BRIEF DESCRIPTION OF DRAWINGS

Embodiment(s) of the present disclosure will be described based on the following figures, wherein:

FIG. 1 is a view showing a state of a rotary electric machine stator which is produced by the laser welding method according to an embodiment, just before inserting coil wires into a stator core;

FIG. 2 is a view showing a state that tip end portions of the coil wires are bent in the circumferential direction and just before the tip end portions are welded mutually;

FIG. 3 is a perspective view showing a state that welding of tip end portions of two coil wires is started;

FIG. 4 is a view showing butting portions of the tip end portions of two coil wires in a see-through manner;

FIG. 5 is a magnified view of an area A in FIG. 4;

FIG. 6 is a top view of FIG. 4, showing a plurality of loops and which indicates a moving locus of laser beam irradiated portions;

FIG. 7 is a magnified view of an area B in FIG. 6 showing a moving locus of a plurality of loops continuously formed by a laser beam;

FIG. 8 is a view corresponding to FIG. 6, showing a laser welding method according to another example embodiment;

FIG. 9 is a view corresponding to FIG. 7, showing a laser welding method according to another example embodiment;

FIG. 10 is a view showing a change of a laser beam scanning speed versus time according to another example embodiment;

FIG. 11 is a view showing a change of laser beam power versus time according to another example embodiment;

FIG. 12A is a view corresponding to FIG. 8, showing a laser welding method according to another example embodiment;

FIG. 12B is a view corresponding to FIG. 8, showing a laser welding method according to another example embodiment;

FIG. 13 is a view corresponding to FIG. 12B for explaining a disadvantage that occurs when laser beam irradiated portions from both welding end portions get closer to mutually collide two molten pools according to the laser welding method shown in FIG. 12B;

FIG. 14 is a view showing a state that a recess is formed on a welding portion at the tip end portions of either coil wire after two molten pools are collided in the case shown in FIG. 12B;

FIG. 15A is a view showing an example of irradiation loci of laser beams when the disadvantage shown in FIG. 13 occurs;

FIG. 15B is a view showing another example of irradiation loci of the laser beams when the disadvantage shown in FIG. 13 occurs;

FIG. 16A is a view showing irradiation loci of laser beams by the laser welding method according to another example embodiment; and

FIG. 16B is a view showing irradiation loci of the laser beams by the laser welding method according to another example embodiment.

### DESCRIPTION OF EMBODIMENTS

Hereinafter, embodiments of the present disclosure will be described with reference to the drawings. Shapes, materials, and quantity described below are illustrative only for the description and can be changed appropriately depending on the specifications of the rotary electric machine stator which is produced by a laser welding method for coil wires. It is noted in the following description that like elements are denoted by the same reference numerals in all the drawings. In addition, the following description uses the previously used same reference numerals when necessary.

In the following descriptions of drawings and embodiments, R indicates a radial direction of the rotary electric machine stator, θ indicates a circumferential direction of the rotary electric machine stator, and Z indicates an axial direction of the rotary electric machine stator. R, Z, and tangent direction of θ are mutually orthogonal.

[Structure of Rotary Electric Machine Stator]

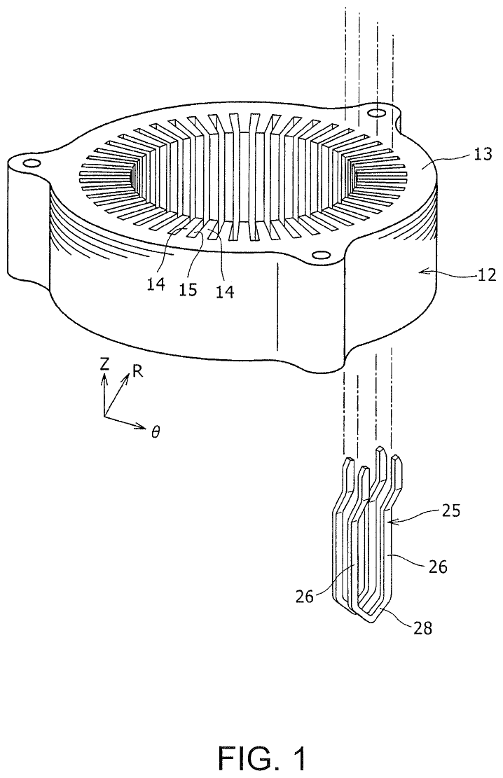

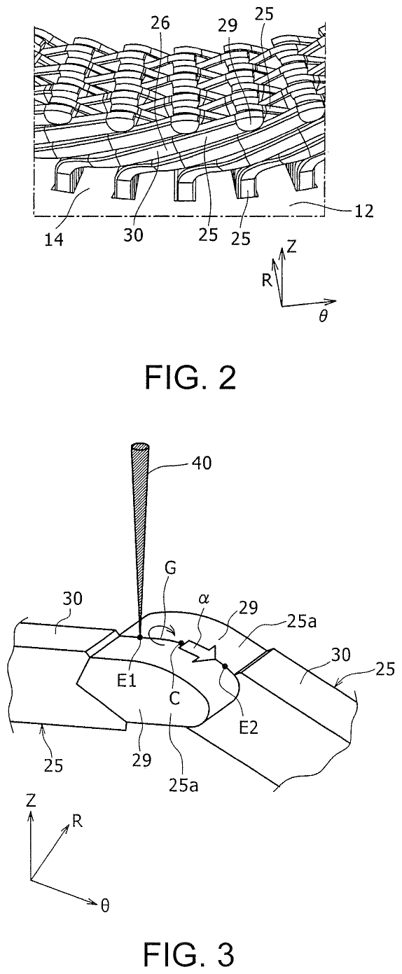

FIG. 1 is a view showing a state just before coil wires 25 are inserted into a stator core 12. FIG. 2 is a view showing a state that tip end portions of the coil wires 25 are bent in the circumferential direction and just before they are welded to each other.

The stator core 12 has a yoke 13 that is annularly arranged on the outer peripheral side, and a plurality of teeth 14 that protrude in a radial direction R from an inner peripheral surface of the yoke 13. The plurality of teeth 14 are arranged at intervals in the circumferential direction θ. A slot 15 is formed as a groove between every two adjacent teeth 14.

[Three-Phase Coil Forming Method]

Each of three-phase coils U, V, W is formed of a plurality of segment coils. The respective segment coils are formed spirally (coil shape) by bending and connecting a plurality of nearly U-shaped coil wires 25 (FIG. 1). Then, each of the plurality of coil wires 25 is inserted into two slots 15 apart each other in the circumferential direction of the stator core 12, portions protruded from one side end in an axial direction Z (upper end in FIG. 1) of the stator core 12 are bent so as to mutually approach in the circumferential direction, and tip end portions of different coil wires 25 which are mutually adjacent and contacted in the radial direction R are welded to form spirally.

Each of the coil wires 25 has two leg portions 26 approximately parallel to each other, and a connection part 28 which is formed in a mountain shape by connecting the ends of the two leg portions 26. As shown in FIG. 2, the coil wires 25 are formed by covering with an insulation film 30 an intermediate part in a lengthwise direction of a conductor element wire 29 which is a rectangular wire having a rectangular cross section and exposing an end of the conductor element wire 29 from the insulation film 30. The conductor element wire 29 is made of a metal material such as copper having high conductivity. As shown in FIG. 3 described later, tip ends of the coil wires 25 have a tapered shape.

As shown in FIG. 2, when the respective segment coils are formed, the plurality of coil wires 25 arranged in the radial direction R are inserted into every two adjacent slots 15 with the tip ends of the leg portions 26 forward from the lower side of the axis (lower end in FIG. 1) of the stator core 12. Then, the tip ends of the two leg portions 26 of the coil wires 25 are protruded from the upper side of the axis Z (upper end in FIG. 1) of the stator core 12. Moreover, as shown in FIG. 2, the plurality of coil wires 25 are bent so that the tip ends of the leg portions 26 get closer each other in the circumferential direction θ and then the tip end portions of the coil wires 25 which are butted in the radial direction R are welded by laser welding so that the plurality of coil wires 25 are connected to form a spiral. Here, the parts exposed from the insulation films 30 of the conductor element wires 29 of the coil wires 25 are welded. Thus, the respective segment coils are wound spirally to straddle the plurality of teeth 14. Each of U, V, and W phase coils is formed by connecting the plurality of segment coils in a ring shape along the circumferential direction θ of the stator core 12.

[Welding Method for Coil Wires]

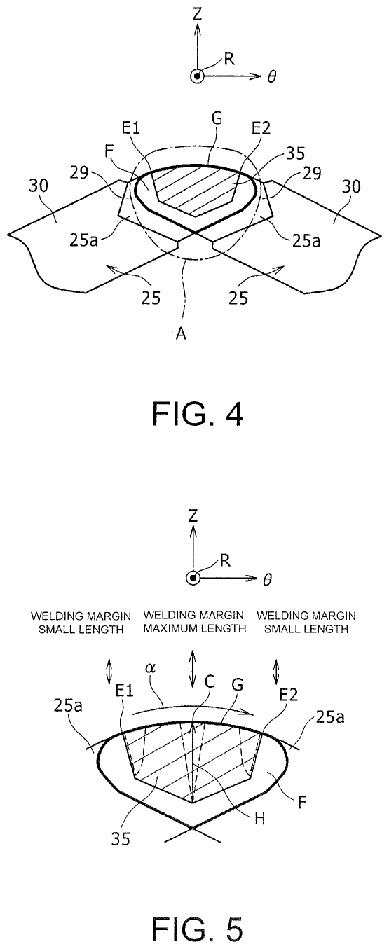

When the above-described rotary electric machine stator is produced, the tip end portions of the two coil wires 25 are welded as follows. FIG. 3 is a perspective view showing a state when welding is started to weld the tip end portions of the two coil wires 25. FIG. 4 is a view showing butting portions of the tip end portions of the two coil wires 25 in a see-through manner. FIG. 5 is a magnified view of an area A in FIG. 4.

As shown in FIG. 3, side surfaces of tip end portions 25a of the two coil wires 25 are butted mutually and welded in the radial direction R. For example, two pressing jigs (not shown) are arranged on both sides of two tip end portions 25a in the radial direction R, and the two tip end portions 25a are pressed to each other by the two pressing jigs. In this state, a laser beam 40 is irradiated from a laser welding machine (not shown). The laser beam 40 is irradiated to an upper end edge G of two butted surfaces F (FIG. 4, FIG. 5) having the side surfaces of the tip end portions 25a of the two coil wires 25 butted mutually to weld the two tip end portions 25a. In FIG. 4 and FIG. 5, the butted surfaces F are indicated by an area whose outer edge is indicated by a thick solid line, and a welding portion 35 is indicated by a shaded area. When the welding portion 35 increases in size within the butted surfaces F, welding strength can be increased further.

When the welding is performed, molten pools are formed along the upper end edge G of the butted surfaces F by scanning the laser beam 40 in a plurality of continuous loop shapes from one welding end portion E1 toward the center (welding center portion C) of the welding portion and further toward the other welding end portion E2. The molten pools are formed when the portions irradiated with the laser beam 40 are scanned in the loop shapes and a metallic base material of the coil wires 25 inside the irradiated portions is melted. Arrow a in FIG. 3 and FIG. 5 indicates a direction of forming the molten pools. FIG. 5 shows outer shapes of three example molten pools by three substantially triangle portions, of which two sides are indicated by a broken line. As the portions irradiated with the laser beam 40 are moved, the molten pools apart from the irradiated portions solidify as the temperature falls, to form the welding portion 35. In addition, when the welding is performed, a movement pitch of the loops of the laser beam 40 is controlled to weld so that the molten pool at the welding center portion C has a greater welding depth H than the other portions as shown in FIG. 5.

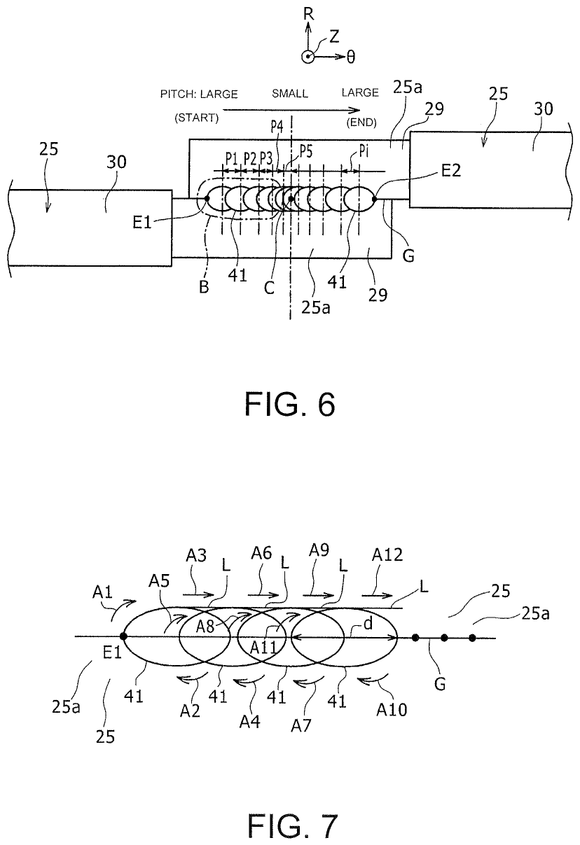

FIG. 6 is a view showing a plurality of loops 41 which indicates a moving locus of laser beam irradiated portions. FIG. 7 is a magnified view of an area B in FIG. 6.

As shown in FIG. 6, the laser beam is irradiated in a plurality of continuous loop shapes from the one welding end portion E1 toward the welding center portion C and further toward the other welding end portion E2 on the upper end edge G of the two butted surfaces. In FIG. 6, (START) indicates an irradiation initiation position of the laser beam and (END) indicates an irradiation termination position of the laser beam. Then, as shown in FIG. 7, the laser beam irradiated portion moves from the one welding end portion E1 toward the other welding end portion E2 (left side in FIG. 7) as indicated by arrows A1, A2, . . . A11, A12 while forming the plurality of loops 41 as part of the moving locus. Adjacent loops 41 are connected along a straight line L, which is a moving locus approximately parallel to the upper end edge G of the butted surfaces, on the tip end portion 25a of one (upper side in FIG. 7) of the coil wires 25. For example, the center of the plurality of loops 41 is on the upper end edge G of the butted surfaces F. When the laser beam-irradiated position is moved, the molten pool distant from the irradiated position solidifies, and the molten pools appear to be moving in the moving direction of the laser beam.

As shown in FIG. 6, welding is performed to enlarge a movement pitch Pi (i=1, 2, 3, . . . ) that is a center-to-center distance of the plurality of loops 41 in the vicinity of the welding end portion E1 that is an irradiation initiation position of the laser beam and the welding end portion E2 that is an irradiation termination position while decreasing the movement pitch Pi in the vicinity of the welding center portion C.

By the above structure, a plurality of small molten pools can be formed from one welding end portion E1 toward the welding center portion C on the upper end edge G of the butted surfaces F. Thus, a diameter (a major axis d of an ellipse when the molten pool is the ellipse (FIG. 7)) of a loop of molten pools can be made smaller compared with a case that the laser beam is scanned in the shape of loops on the tip end portion of a single coil wire different from the butted surfaces of two coil wires as in JP 2018-20340 A to form molten pools and to gradually enlarge the loops to reach the upper end of the butted surfaces. Therefore, the starting end and the terminal end of the loop can be connected in a short time when each loop 41 is formed on the butted surfaces F, so that the surface temperature in the vicinity of the starting end can be kept high, and solidification due to a temperature drop in the vicinity of the starting end of the molten pool can be suppressed. Therefore, there can be suppressed taking of the energy of the laser beam 40 for remelting in the vicinity of the starting end of the molten pools, and the energy is used for further melting in the vertical direction (stator axis direction Z) of the butted surfaces F and the welding area can be expanded in the vertical direction. In addition, the welding area can be further increased by welding so that the molten pool at the welding center portion C comes to have a greater welding depth than the other pools. Specifically, when the welding is performed with the movement pitch of the loops 41 varied as described above, many loops 41 are concentrated at the welding center portion C, so that an incoming heat amount to the tip end portions 25a of the coil wires 25 increases, and the welding depth becomes large. In addition, at an initial stage of irradiation of the laser beam 40, irradiation heat is apt to be taken by a temperature increase of the whole of the two coil wires 25, and the molten pools are liable to become shallow. However, its influence is reduced toward the welding center portion C, and the molten pools can be made deeper. Thus, the welding depth at the welding center portion C can also be increased. As shown in the above-described FIG. 4 and FIG. 5, the butted surfaces F can have many of the area occupied by the welding portion 35, because a welding margin in the vertical direction becomes large at the position corresponding to the center of the upper end edge G. Therefore, the welding areas of the tip end portions 25a of the two coil wires 25 can be increased. Consequently, the welding strength of the two coil wires 25 can be enhanced.

When a plurality of loops are on the upper end edge G of the butted surfaces F, the center of the plurality of loops may not be on the upper end edge G. In addition, the laser beam 40 may have an irradiation initiation position and an irradiation termination position at positions different from the welding ends at both ends of the welding portion 35.

[Another Example of Welding Method for Coil Wires]

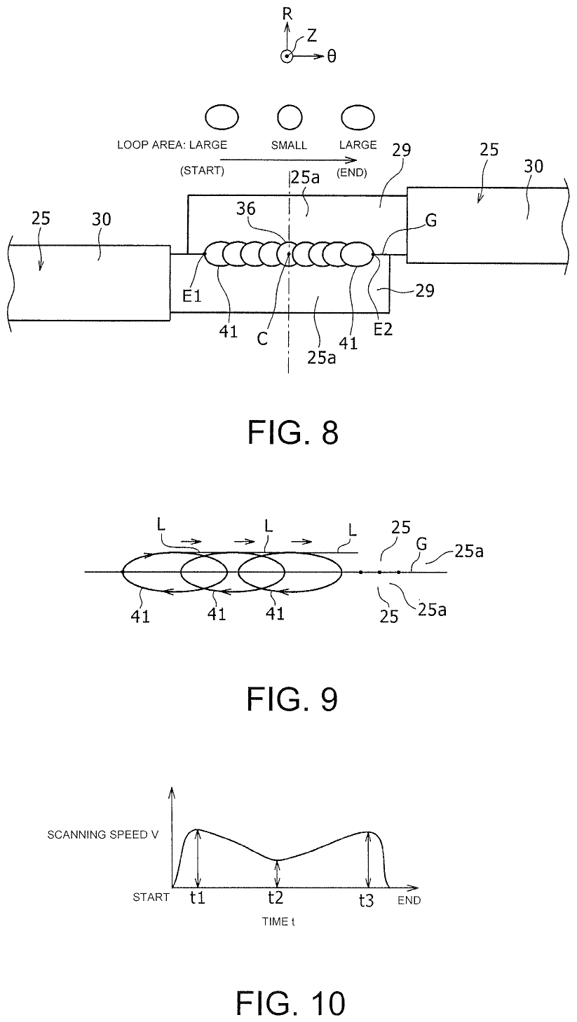

FIG. 8 shows a laser welding method according to another example embodiment. In this case, when the laser beam is irradiated in a plurality of continuous loop shapes on the upper end edge G of two butted surfaces, a loop area by the laser beam is controlled to perform welding so that the molten pool at the welding center portion C comes to have a greater welding depth than the other molten pools. Specifically, the plurality of loops 41 are determined to have an increased shape in the vicinity of the welding end portion E1 at an irradiation initiation position of the laser beam and in the vicinity of the welding end portion E2 at an irradiation termination position but a decreased shape in the vicinity of the intermediate position; that is, between the two welding end portions E1 and E2, corresponding to the welding center portion C. For example, the loops 41 are formed in an ellipse in the vicinity of the two welding end portions E1 and E2, but the loops 41 are formed in a perfect circle having substantially the same diameter as the minor axis of the welding end portions E1 and E2 in the vicinity of the welding center portion C. Thus, the loop area in the vicinity of the welding end portions E1, E2 becomes larger than the loop area in the vicinity of the welding center portion C. The loop area is gradually reduced between the welding end portions E1, E2 and the welding center portion C by gradually bringing the loop 41 to the perfect circle as it is made closer to the welding center portion C. The plurality of loops 41 are determined to have substantially the same movement pitch, but the movement pitch may be reduced as the loops 41 come close to the welding center portion C, similar to the structure shown in FIG. 6.

When the loops 41 are reduced in size in the vicinity of the welding center portion C as described above, the energy of the laser beam is easily concentrated at a narrow-area portion. The smaller the area of the loop 41, the larger the incoming heat amount per unit area within the loop 41, and the deeper the molten pools become. Accordingly, the welding center portion C can have a greater welding depth larger other welding portions. In this example, other configurations and actions are similar to those shown in FIG. 1 to FIG. 7.

FIG. 9 shows a laser welding method according to another example embodiment. FIG. 10 is a view showing a change of a laser beam scanning speed versus time t according to another example embodiment.

In this case, when the laser beam is irradiated in a plurality of continuous loop shapes to the upper end edge G of two butted surfaces, a scanning speed of the laser beam is controlled to perform welding so that the molten pool at the welding center portion C comes to have a greater welding depth than other molten pools. Specifically, each of the plurality of loops 41 respectively has substantially the same shape and pitch as shown in FIG. 9, but as shown in FIG. 10, a laser beam scanning speed (laser scanning speed) V is controlled to maximize it at a time t1 just after starting irradiation of the laser beam and a time t3 just before ending irradiation and to reduce at an intermediate time point t2 in the irradiation time. Accordingly, the laser beam scanning speed V becomes high in the vicinity of the welding end portions E1 and E2 but the scanning speed becomes low in the vicinity of the welding center portion C. The lower the laser beam scanning speed V, the larger the incoming heat amount per unit area within the loop 41 and the deeper the molten pools. Therefore, the welding center portion C can be increased in welding depth to have a greater welding depth than the other portions. In this example, other configurations and actions are similar to those in FIG. 1 to FIG. 7.

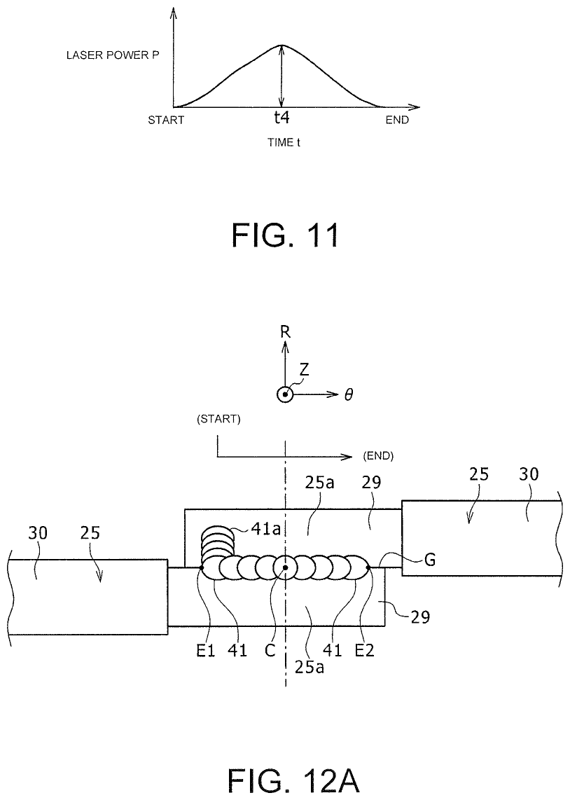

FIG. 11 is a view showing a change of laser beam power against a time t according to another example embodiment. In this case, when the laser beam is irradiated in a plurality of continuous loop shapes to the upper end edge of two butted surfaces, the laser beam power is controlled to perform welding so that the molten pool at the welding center portion C comes to have a greater welding depth than other molten pools. Specifically, the plurality of loops are determined to have substantially the same shape, pitch, and scanning speed, but as shown in FIG. 11, laser power P is controlled to gradually increase from the start of irradiating the laser beam to become maximum at an intermediate irradiation time point t4 and to gradually lower toward the termination of irradiation. Thus, the laser power lowers in the vicinity of the welding end portions E1 and E2 but increases in the vicinity of the welding center portion C. The higher the laser beam power P, the higher the incoming heat amount within the loop 41 and the deeper the molten pool. Therefore, the welding center portion C can have greater welding depth than other portions. In this example, other configurations and actions are similar to those in FIG. 1 to FIG. 7.

It is noted that the configurations in FIG. 1 to FIG. 7, the configuration in FIG. 8, the configurations in FIG. 9 and FIG. 10, and the configuration in FIG. 11 described above can also be combined with the control of the laser beam having one or more different configurations.

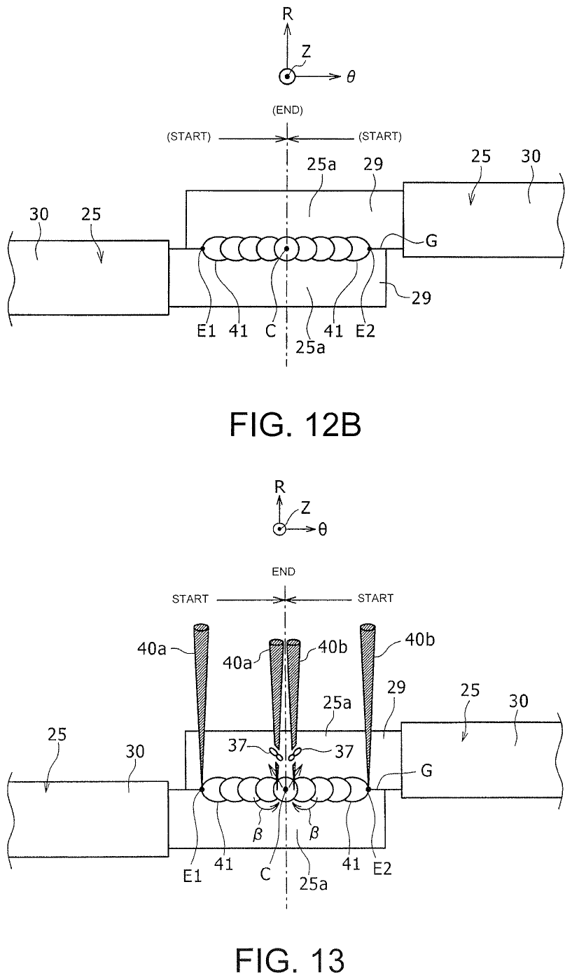

FIG. 12A shows a laser welding method according to another example embodiment. In this example, different from the configurations in FIG. 8, a preliminary irradiation step is performed to preliminarily irradiate the laser beam to the tip end portions 25a of one coil wire 25 (upper side in FIG. 12A) before a welding step that forms a welding portion connecting welding ends of the two welding end portions E1, E2. In the preliminary irradiation step, molten pools are formed by scanning the laser beam in the loop shapes in the thickness direction (vertical direction in FIG. 12A) of the tip end portion 25a of the one coil wire 25. Loops 41a to be formed here are determined to have substantially the same size as the loop 41 which is formed at the welding end portion E1. In the subsequent welding step, the laser beam is scanned in a plurality of continuous loop shapes from the welding end of the welding end portion E1 toward the welding end of the welding end portion E2 to form a plurality of molten pools. The preliminary irradiation step is performed to increase the temperature of the coil wires 25 as a whole to a prescribed level so that the laser power is hardly taken for the temperature rise of the whole coil wires in the subsequent welding step. Moreover, in the preliminary irradiation step, the welding area can be increased without increasing the laser power uselessly, by keeping the laser power small and increasing the laser power in the welding step. In this example, other configurations and actions are similar to those in FIG. 8. The configuration in this example can also be combined with any of the other configurations.

FIG. 12B shows a laser welding method according to another example embodiment. In this example, molten pools are formed on the upper end edge G of two butted surfaces by scanning the laser beam in a plurality of continuous loop shapes from both of the two welding end portions E1, E2 toward the welding center portion C on the upper end edge G. In addition, each laser beam scanning is terminated at the welding center portion C. Then, the laser beam scanning may be started simultaneously from both of the two welding end portions E1, E2, but it may be determined that after the laser beam is scanned from the welding end portion E1 toward the welding center portion C, the laser beam is scanned from the welding end portion E2 toward the welding center portion C. In this example, other configurations and actions are similar to those in FIG. 8. The configuration in this example may be combined with any of the other configurations.

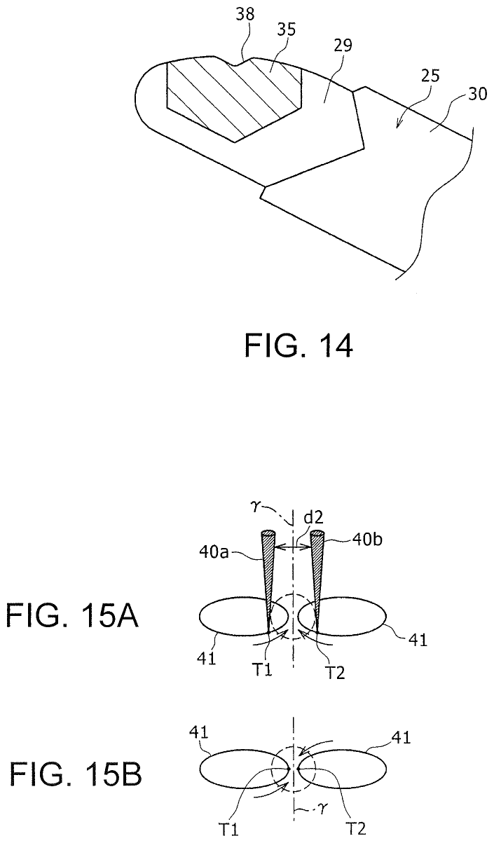

FIG. 13 is a view corresponding to FIG. 12B, explaining a disadvantage that occurs when the irradiated portions of laser beams 40a, 40b approach mutually from both of the welding end portions E1, E2 and two molten pools are mutually collided according to the laser welding method shown in FIG. 12B. FIG. 14 is a view showing a state that a recess 38 is formed in the welding portion 35 at the tip end portion 25a of either coil wire 25 after two molten pools are collided in the case shown in FIG. 12B.

As shown in FIG. 12B, when the laser beams 40a, 40b are scanned from the two welding end portions E1, E2 toward the welding center portion C, the welding areas at the tip end portions 25a of the two coil wires 25 are possibly reduced, depending on a loop forming direction by the laser beams. Specifically, as shown in FIG. 13, when two molten pools, which are formed by irradiation of the two laser beams 40a, 40b, mutually approach from the two welding end portions E1, E2 toward the welding center portion and push each other as indicated by arrows β, partial scattering is caused due to a sudden increase in the heat energy of the molten pools, and scatter portions 37 may be produced on one (upper side in FIG. 13) of the coil wires 25. The molten pools are formed of a melted base material of the coil wires 25 which are made of a metal material such as copper. Therefore, when scattering occurs from the molten pools, the base material is locally reduced with the molten pools in a solidified state, and the recess 38 is formed in the welding portion 35 of the coil wires 25 as shown in FIG. 14. In such a case, the welding areas of the tip end portions 25a of the two coil wires 25 are reduced, and welding strength might be lowered. For example, when the loops 41 of the laser beams 40a, 40b are formed by the methods shown in FIG. 15A and FIG. 15B explained below, the above-described scattering occurs from the molten pools.

FIG. 15A is a view showing an example of irradiation loci of the laser beams 40a, 40b when the disadvantage shown in FIG. 13 is caused. FIG. 15B is a view showing another example of irradiation loci of the laser beams 40a, 40b when the disadvantage shown in FIG. 13 is caused. FIG. 15A shows a case where two loops 41 formed by the two laser beams 40a, 40b are formed in opposite directions from each other, and FIG. 15B shows a case where two loops 41 formed by the two laser beams 40a, 40b are formed in same directions. In FIG. 15A and FIG. 15B, points T1, T2 indicate two irradiated portions 78 by two laser beams 40a, 40b at the same time. In both of FIG. 15A and FIG. 15B, the points T1, T2 are approaching to a point which becomes a welding center portion on a dot-and-dash line γ at the same time. Thus, the two molten pools formed by the two laser beams 40a, 40b push against each other, and the above-described disadvantage is easily caused.

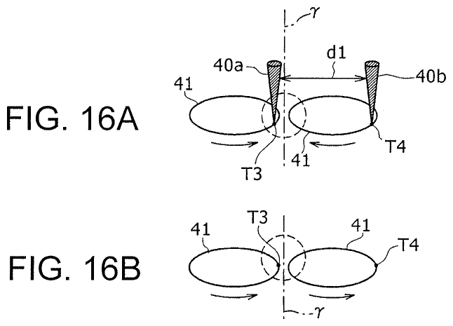

FIG. 16A and FIG. 16B are views each showing irradiation loci of the laser beams 40a, 40b according to a laser welding method of another example embodiment invented to eliminate the above-described disadvantage. In the example shown in FIG. 16A, two loops 41 formed by the two laser beams 40a, 40b are formed in opposite directions, similar to the case shown in FIG. 15A. As shown in FIG. 12B, the molten pool is formed at the center of the welding portion on the upper end edge of the butted surfaces of the two coil wires by scanning the laser beam in a plurality of continuous loop shapes from the both welding end portions. In FIG. 16A, in this case, when the irradiated portion at the position of a point T3 on one (left side in FIG. 16A) of the loops 41 by the laser beam 40a is at an end portion (right end portion in FIG. 16A) on the side of the welding center portion, the irradiated portion at the position of a point T4 on the other (right side in FIG. 16A) of the loops 41 by the laser beam 40b is at an end portion (right end portion in FIG. 16A) on the opposite side of the welding center portion. In FIG. 16A, the molten pools are suppressed from scattering easily, because a distance d1 between the two laser beams 40a and 40b can be made larger than a distance d2 in FIG. 15A.

In the example shown in FIG. 16B, the two loops 41 formed by the two laser beams are formed in the same directions, similar to the case in FIG. 15B. As shown in FIG. 12B, the molten pool is formed at the center of the welding portion on the upper end edge of the butted surfaces of the two coil wires by scanning the laser beam in a plurality of continuous loop shapes from the both welding end portions. In FIG. 16B, in this case, when the laser beam irradiated portion on one (left side in FIG. 16B) of the loops 41 is at an end portion (position of the point T3) on the side of the welding center portion, the laser beam irradiated portion on the other (right side in FIG. 16B) of the loops 41 is at an end portion (position of the point T4) on the opposite side of the welding center portion. Also in FIG. 16B, the distance between the two laser beams can be made larger than that in FIG. 15B similar to FIG. 16A, thereby suppressing easy scattering of the molten pools.

1. A laser welding method for coil wires, the method comprising welding two coil wires by irradiating a laser beam to an upper end edge of butted surfaces of side surfaces of tip end portions of the two coil wires, wherein a molten pool is formed at the center of a welding portion on the upper end edge of the butted surfaces of the two coil wires by scanning the laser beam in a plurality of continuous loop shapes from one or both welding end portions, and welding is performed to make the molten pool at the center portion of the welding portion greater in welding depth than other molten pools by controlling at least one among a movement pitch, a loop area, a laser scanning speed, and a laser power of loops of the laser beam.

2. The laser welding method for coil wires according to claim 1, wherein the two coil wires are welded to have a movement pitch of the plurality of loops enlarged in the vicinity of the both welding end portions but made smaller in the vicinity of the center portion of the welding portion.

3. The laser welding method for coil wires according to claim 1, wherein the two coil wires are welded to have loop areas of the plurality of loops enlarged in the vicinity of the welding end portions of the coil wires but made smaller in the vicinity of the center portion of the welding portion.

4. The laser welding method for coil wires according to claim 1, wherein the two coil wires are welded to have the laser scanning speed increased in the vicinity of both welding end portions but reduced in the vicinity of the center portion of the welding portion.

5. The laser welding method for coil wires according to claim 1, wherein the two coil wires are welded to have the laser power reduced in the vicinity of both welding end portions but increased in the vicinity of the center portion of the welding portion.

6. The laser welding method for coil wires according to claim 1, wherein a preliminary irradiation step is performed by scanning a laser beam in a loop shape in a thickness direction of one of the coil wires before a welding step that forms the welding portion connecting the welding ends of the both welding end portions on the upper end edge of the butted surfaces of the two coil wires.

7. The laser welding method for coil wires according to claim 1, wherein in a case where the molten pool is formed at the center of the welding portion on the upper end edge of the butted surfaces of the two coil wires by scanning the laser beam in a plurality of continuous loop shapes from the both welding end portions, when the laser beam irradiated portion on one of the two loops which are formed by the two laser beams and approaching mutually is at an end portion on the side of the center portion of the welding portion, the two coil wires are welded to have the laser beam irradiated portions on the other of the loops at an end portion on the side opposite to the side which is the center portion of the welding portion.
